(19) United States
(12) Patent Application Publication
(10) Pub. No.: US 2022/0296458 A1
(43) Pub. Date: Sep. 22, 2022

(54) SOMATOSENSATION DEVICE FOR LOSS OF FEELING IN THE FOOT

(71) Applicants: Thomas Sugar, Chandler, AZ (US); Claudio Vignola, Lodi Vecchio (IT)

(72) Inventors: Thomas Sugar, Chandler, AZ (US); Claudio Vignola, Lodi Vecchio (IT)

(21) Appl. No.: 17/655,690

(22) Filed: Mar. 21, 2022

Related U.S. Application Data
(60) Provisional application No. 63/164,128, filed on Mar. 22, 2021.

(51) Int. Cl. A61H 9/00

(52) U.S. Cl. CPC A61H 9/0085; A61H 2205/12; A61H 2201/1642; A61H 2201/165; A61H 2201/5061

(57) ABSTRACT

A device can comprise a force actuation system at least partially disposed in a shoe assembly. The force actuation system can be a passive or active actuation system. The force actuation system can be configured to determine the foot pressure during use of the device. The device can further comprise a force indication system including a plurality of force sensors and a light array, each force sensor disposed in an insole assembly and the light array mounted to the person.

### CROSS-REFERENCE TO RELATED APPLICATIONS

This application is a non-provisional of, and claims priority to and the benefit of, U.S. Provisional Application No. 63/164,128, entitled “Somatosensation Device for Loss of Feeling in the Foot,” filed on Mar. 22, 2021. The disclosure of the foregoing application is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to actuation systems, and in particular to systems for use by individuals afflicted by neurological conditions, such as in particular, the loss of feeling in the foot.

### BACKGROUND

Patients who have suffered from diabetes often have residual neurological deficiencies. Among these deficiencies is sometimes an inability to gauge force or loss of feeling in their foot. As a result, ambulation can be poor, and trips and falls can occur. This can have a profound effect on standard of living, as walking is inhibited. As such, a wearable device is desirable, for example one designed to substitute the loss of feeling in the foot by pressing on nerves on the surface of the leg in particular the shank between the knee and the ankle.

Peripheral neuropathy caused by diabetes results in nerve damage. The nerve damage can lead to numbness, loss of sensation in the feet or legs. It is estimated that there are over 20 million people in the United States with peripheral neuropathy. Accordingly, improved systems and devices for care and treatment remain desirable.

### SUMMARY

A device is disclosed herein. The device can comprise: an insole assembly comprising a first bladder; and a force actuation system comprising the first bladder and a second bladder, the first bladder in fluid communication with the second bladder, the force actuation system configured to displace a fluid from the first bladder to the second bladder in response to displacement of the first bladder.

In various embodiments, the force actuation system can further comprise a tube assembly, the first bladder can be in fluid communication with the second bladder via the tube assembly, and the second bladder can be configured to contact a person during use of the device. The tube assembly can comprise a first tube, a connector, and a second tube, the first tube disposed between a first port of the connector and the first bladder, the second tube disposed between the second bladder and a second port of the connector. The connector can comprise a third port, and the third port can be sealed, the third port configured to adjust a bias pressure. The second bladder can be configured to create a pressure on a nerve of a leg. The device can be used as a medical device and a non-medical device. The first bladder can be configured for passive actuation during use of the device. The device can further comprise a force indication system comprising a plurality of force sensors, each force sensor disposed in the insole assembly. The device can further comprise an attachment mechanism, wherein the attachment mechanism comprises the second bladder. The force actuation system can further comprise a third bladder and a fourth bladder, the third bladder in fluid communication with the fourth bladder, the insole assembly comprising the third bladder, the attachment mechanism comprising the fourth bladder, the first bladder disposed proximate a heel of a user when in use, the second bladder disposed proximate a toe of the user when in use.

A force actuation system for a device is disclosed herein. The force actuation system can comprise: a first bladder configured to be disposed proximate a foot of a user when in use; and an attachment mechanism, comprising: a second bladder in fluid communication with the first bladder, the force actuation system configured to displace a first fluid from the first bladder to the second bladder in response to displacement of the first bladder.

In various embodiments, the force actuation system can further comprise: a third bladder configured to be disposed proximate a toe of the user when in use, the first bladder configured to be disposed proximate a heel of the user when in use; and a fourth bladder in fluid communication with the third bladder, the force actuation system configured to displace a second fluid from the third bladder to the fourth bladder in response to displacement of the second bladder. The attachment mechanism can be configured to couple to a leg of the user. The force actuation system can further comprise an insole assembly comprising the first bladder. The force actuation system can further comprise a piece of footwear, wherein the first bladder is disposed in the piece of footwear. The force actuation system can be a passive force actuation system. The second bladder can be configured to be disposed proximate a nerve of the user when in use. The attachment mechanism can comprise an attachment strap.

A control system for a device is disclosed herein. In various embodiments, the control system can comprise: a first force sensor disposed in an insole; a second force sensor disposed in the insole; a transmitter in electrical communication on with the first force sensor and the second force sensor; a receiver; a controller in electrical communication with the receiver; and a tangible, non-transitory memory configured to communicate with the controller, the tangible, non-transitory memory having instructions stored thereon that, in response to execution by the controller, cause the controller to perform operations comprising: receiving, by the controller and through the receiver, a first force measurement from the first force sensor, and commanding, by the controller, one of actuation of an actuator or illumination of a light based on the first force measurement from the first force sensor.

In various embodiments, the control system can further comprise: an insole assembly comprising the first force sensor, the second force sensor, and the transmitter; and a wearable device comprising the receiver and the controller.

The foregoing features and elements can be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting. The contents of this section are intended as a simplified introduction to the disclosure and are not intended to limit the scope of any claim.

### BRIEF DESCRIPTION OF THE DRAWINGS

With reference to the following description and accompanying drawings:

FIG. 1 illustrates a perspective view of a wearable device in use, in accordance with various embodiments;

FIG. 2A illustrates a top down view of an insole assembly without the wearable portion, in accordance with various embodiments;

FIG. 2B illustrates a perspective view of the insole assembly, in accordance with various embodiments;

FIG. 3 illustrates a perspective view of an attachment mechanism of a wearable device in use, in accordance with various embodiments; and

FIG. 4A illustrates a tube assembly for a force actuation system for a wearable device, in accordance with various embodiments;

FIG. 4B illustrates a tube assembly for a force actuation system for a wearable device, in accordance with various embodiments;

FIG. 5A illustrates a tube assembly for a force actuation system for a wearable device, in accordance with various embodiments;

FIG. 5B illustrates a tube assembly for a force actuation system for a wearable device, in accordance with various embodiments;

FIG. 6A illustrates a force indication system for use in a wearable device, in accordance with various embodiments;

FIG. 6B illustrates a force indication system for use in a wearable device, in accordance with various embodiments;

FIG. 7 illustrates a force control system for use in a wearable device, in accordance with various embodiments;

FIG. 8 illustrates a perspective view of a wearable device in use, in accordance with various embodiments;

FIG. 9A illustrates a top down view of the insole assembly without the wearable portion, in accordance with various embodiments;

FIG. 9B illustrates a perspective view of the insole assembly, in accordance with various embodiments;

FIG. 10A illustrates a control system for an actuation system for a wearable device, in accordance with various embodiments; and

FIG. 10B illustrates a control system for an actuation system for a wearable device, in accordance with various embodiments.

### DETAILED DESCRIPTION

The following description is of various exemplary embodiments only, and is not intended to limit the scope, applicability, or configuration of the present disclosure in any way. Rather, the following description is intended to provide a convenient illustration for implementing various embodiments including the best mode. As will become apparent, various changes can be made in the function and arrangement of the elements described in these embodiments without departing from principles of the present disclosure.

For the sake of brevity, conventional techniques and components are not be described in detail herein. Furthermore, the connecting lines shown in various figures contained herein are intended to represent exemplary functional relationships and/or physical couplings between various elements. It should he noted that many alternative or additional functional relationships or physical connections can be present in exemplary systems and/or components thereof, and associated methods of use.

In various exemplary embodiments, a system can be desirable for people who have peripheral neuropathy and have lost feeling in their feet to substitute for any sensory loss, such as an inability to gauge force or pressure on his or her feet. Exemplary embodiments are intended to be, or function as, a wearable device designed for improvement in walking.

Exemplary embodiments are intended for use by individuals afflicted by neurological conditions, for example those that cannot sense the force exerted against or by their feet. The device can utilize a passive system loaded with fluid that translates the force exerted at certain areas of the affected foot, to another location. The device can further provide an increased ability to sense that force and supply that information to the person. A separate electrical system supplements a light touch threshold of the device and emits a visual cue to expand detection.

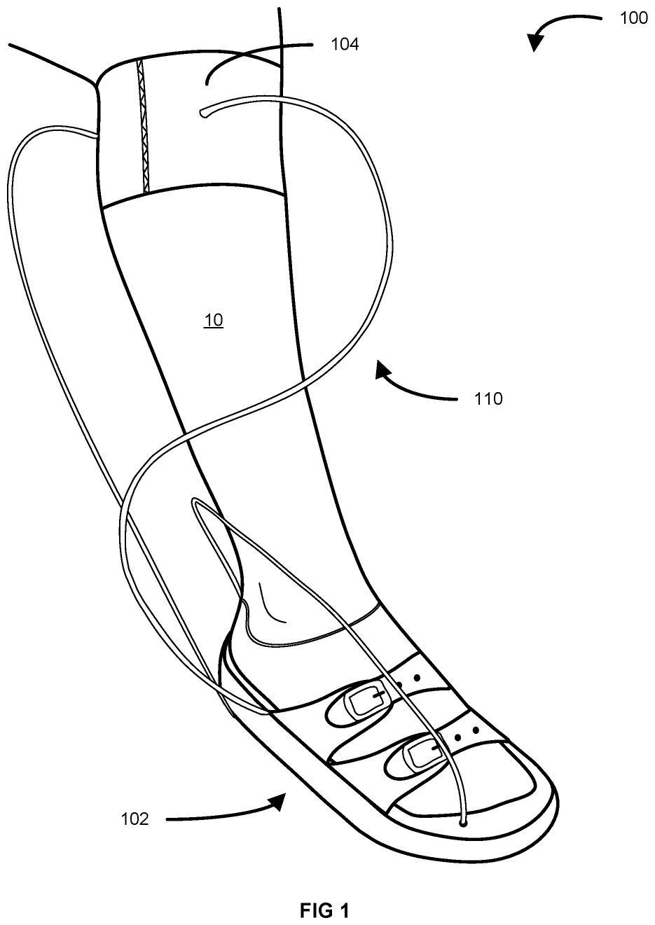

Referring now to FIG. 1, a perspective view of a device 100 in use is illustrated, in accordance with various embodiments. The device 100 comprises an insole assembly 102 and an attachment mechanism 104. In various embodiments, the insole assembly 102 can be configured to be inserted into a shoe, a sandal, or any other component configured to be wearable on a foot of a user 10. In various embodiments, the insole assembly 102 can be integral with a shoe, a sandal or any other component configured to be wearable on a foot of a user 10. In various embodiments, the attachment mechanism 104 is configured to couple to a body part of a user 10 (e.g., above the calf, on the shank, or any other area of a leg of user 10). In various embodiments, the attachment mechanism 104 comprises a cuff, a strap, or any other component configured to couple to a leg of the user 10.

In various embodiments, the device 100 comprises a force actuation system 110. The force actuation system 110 is configured to redistribute a force supplied by a person from one location (e.g., a ball or a heel) of the foot to another location point on the body (e.g., a pressure point on the leg, or any other location on the body). The force can be redistributed in response to the foot creating a pressure on the insole assembly 102 during use of the device 100. While disclosed herein as being a passive actuation system, an active actuation system for a force actuation system 110 is within the scope of this disclosure. For example, a controller can be coupled to actuators controlling fluid lines to various areas of the insole assembly 102 and/or control the actuators in response to a force against the foot or supplied by the person based on where additional force would be beneficial. In various embodiments, a passive actuation system can be cheaper, cost less, and can be lighter than an active actuation system.

In various embodiments, the force actuation system 110 can provide a near instantaneous force to a location with feeling (e.g., a pressure point such as the peroneal nerve or the like) in response to generating a force to a location without feeling (e.g., a ball or a heel of a user 10). In this regard, the user 10 can understand when a heel of the user 10 and/or a ball of the user 10 contacts the ground.

In various embodiments, the force actuation system 110 comprises a bladder disposed in, or mounted on, insole assembly 102 and a bladder disposed in, or coupled to, the attachment mechanism 104 as described further herein.

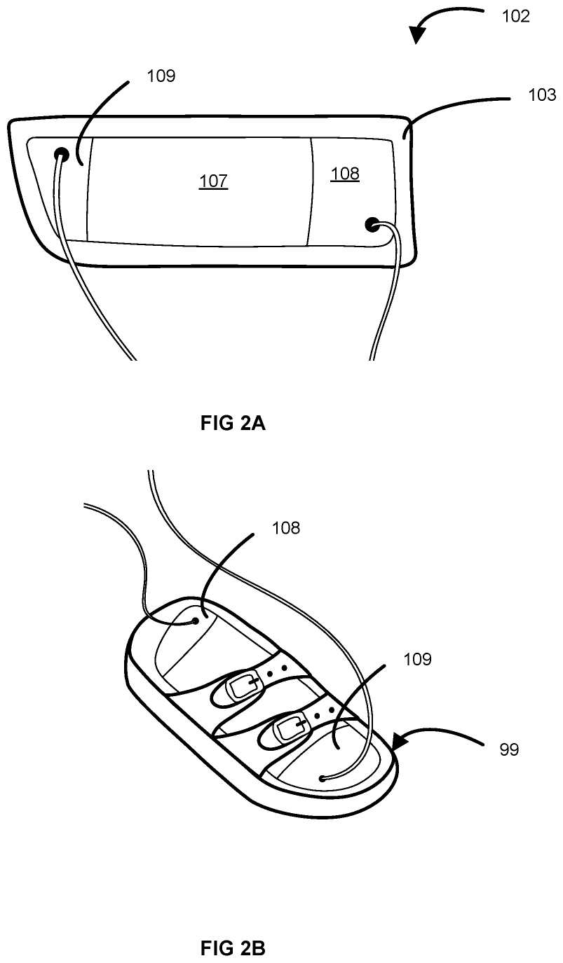

With reference to FIG. 2A and FIG. 2B, a top down view of the insole assembly 102 of the device 100 without the wearable portion (e.g., the shoe, the sandal, etc.) (FIG. 2A) and a perspective view of the insole assembly 102 (FIG. 2B), are illustrated in accordance with various embodiments. In various embodiments, the insole assembly 102 includes an insole 103 and at least one bladder (e.g., bladder 108 and/or bladder 109). In various embodiments, bladder 108 is disposed at, or proximate, a heel of the insole assembly 102 and bladder 109 is disposed at, or proximate, a ball of the insole assembly 102.

In various embodiments, bladders 108, 109 are integral with the insole 103 or a wearable device 99. In various embodiments, the insole 103 and the bladders 108, 109 can be distinct components and physically coupled together (e.g., via adhesives, sewing, or any other coupling method). In various embodiments, the bladders 108, 109 can be fluidly coupled to respective bladders disposed in, or coupled to, the attachment mechanism 104 of the device 100 from FIG. 1 as described further herein.

In various embodiments, a middle portion 107 of the insole assembly 102 extends from the bladder 108 to the bladder 109. The middle portion 107 can comprise a typical insole material, such as leather, foam rubbers, or any other polymeric material. In various embodiments, the middle portion 107 is not a bladder. In various embodiments, by disposing the bladders 108, 109 only in high pressure locations of an insole assembly 102, a greater and/or more consistent force can be transferred to a second location of the user 10 (e.g., proximate a pressure point) relative to lower pressure locations of the insole assembly 102). The greater and more consistent force can indicate accurately and/or consistently a relative pressure (i.e., relative to other steps by the user 10 from FIG. 1) applied during a stepping motion of the user 10. Additionally, the greater and more consistent force can indicate consistently which part of the foot (i.e., the ball or the heel) is contacting the ground and when. Thus, a user 10 from FIG. 1 can have a better understanding of variations in pressure generated from a walk or a run by a user 10 from FIG. 1 based on the bladders 108, 109 only being in high pressure locations.

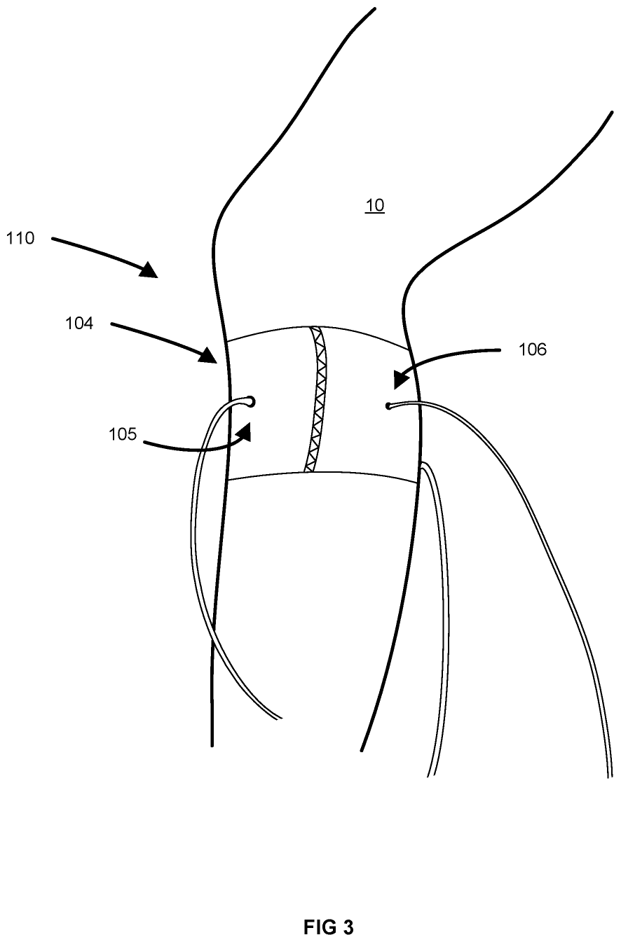

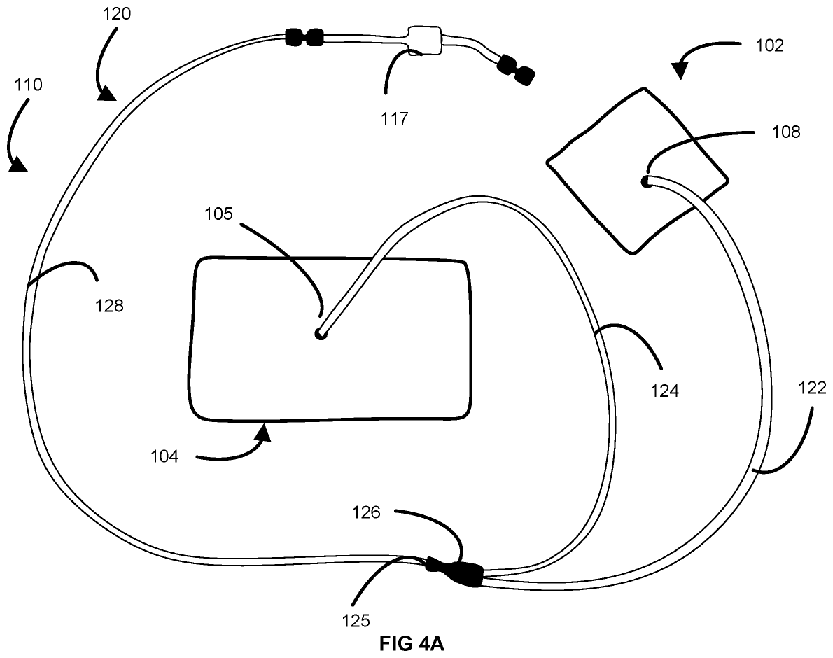

Referring now to FIG. 3, a side view of the attachment mechanism 104 of the device 100 from FIG. 1 in use, is illustrated, in accordance with various embodiments. In various embodiments, the attachment mechanism 104 can be configured to be coupled to a leg of the user 10 from FIG. 1, for example above the calf, on the shank, or any other area of a leg. The attachment mechanism 104 can comprise any attachment mechanism known in the art, such as a hook and loop fastener, a clip, a hook, or any other fastening attachment mechanism. Although disclosed herein as being coupled to the shank of the person, an attachment mechanism 104 can be configured to couple to any part of a person's leg, and the device 100 is not limited in this regard. The attachment mechanism 104 can be configured to house, or contain, a portion of the force actuation system 110 of the device 100. For example, the attachment mechanism 104 can house a fluid pump, at least one bladder (e.g., bladders 105, 106) and/or any other component of a force actuation system 110. In various embodiments, bladders 105, 106 can be integral with the attachment mechanism 104.

In various embodiments, bladders 105, 106 can be discrete components of an attachment strap or a cuff of the attachment mechanism 104. In various embodiments, each bladder (e.g., bladder 105 and bladder 106) of the attachment mechanism 104 can be fluidly coupled to a respective bladder (e.g., bladder 108 for bladder 105 and bladder 109 for bladder 106) of the insole assembly 102 from FIG. 1. For example, with combined reference to FIGS. 2A, 2B, and 3, bladder 105 of the attachment mechanism 104 can be fluidly coupled to bladder 108 of insole assembly 102, and bladder 106 of the attachment mechanism 104 can be fluidly coupled to bladder 109 of insole assembly 102, in accordance with various embodiments. In various embodiments the attachment mechanism 104 can be configured such that bladders 105, 106 inflate in response to a person's foot (e.g., a user 10 from FIG. 1) creating a pressure on a respective bladder (e.g., bladder 108 and/or bladder 109) of the insole assembly 102 from FIG. 2A-B in response to taking a step as described further herein.

Any number of bladders for attachment mechanism 104 and insole assembly 102 is within the scope of this disclosure. Although illustrated as having a corresponding number of bladders, the present disclosure is not limited in this regard (i.e., there can be more bladders in an insole assembly 102 than in the attachment mechanism 104 and vice versa)

In various embodiments, by having two bladders (bladders 108, 109) for the insole assembly 102, each bladder corresponding to (i.e., independently as described further herein) a bladder for the attachment mechanism 104 (i.e., bladder 108 is directly fluidly coupled to bladder 105 and bladder 109 is directly fluidly coupled to bladder 106), a user 10 from FIG. 1 knows which part of the foot of the user 10 has contacted the ground throughout a walk or a run by the user 10. Thus, even without any feeling a foot of the user 10 from FIG. 1, the user 10 can still know when and how much pressure the user 10 is applying by walking or running.

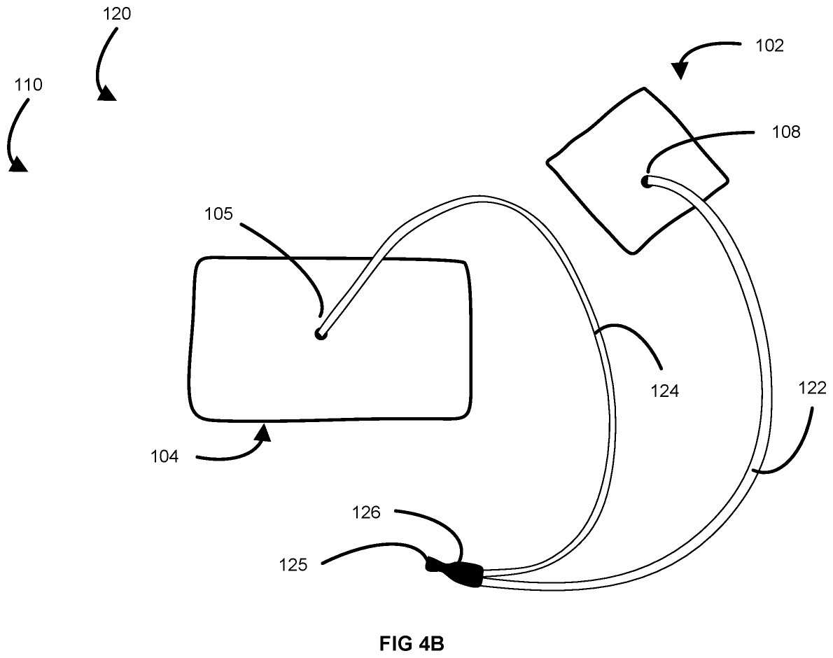

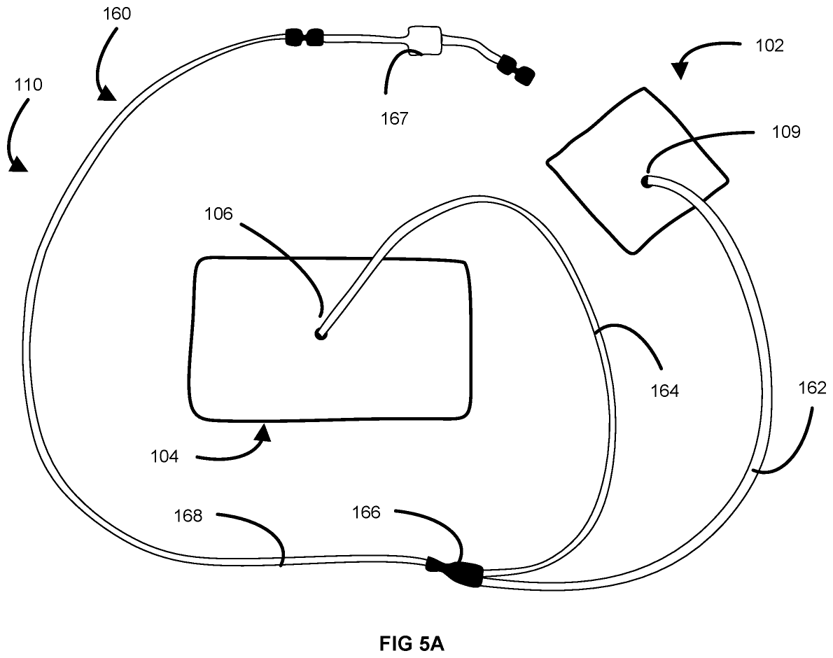

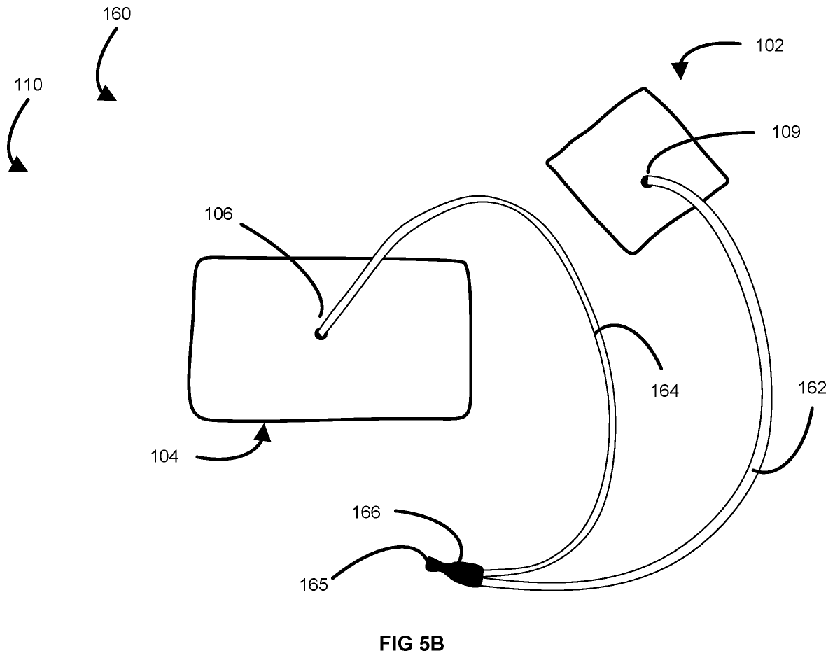

Referring now to FIGS. 4A and 5A, a first tube assembly 120 (FIG. 4A) and a second tube assembly 160 (FIG. 5A) of the force actuation system 110 for use in device 100 from FIG. 1 is illustrated, in accordance with various embodiments. In various embodiments, the force actuation system 110 can comprise a tube assembly (e.g., tube assembly 120 and tube assembly 160) for each fluidly coupled bladder pairs. In this regard, each tube assembly (e.g., tube assembly 120 and tube assembly 160) can be fluidly isolated from any other tube assemblies in the force actuation system 110. Thus, in various embodiments, the first tube assembly 120 can comprise the bladder 105 of the attachment mechanism 104 and the bladder 108 of the insole assembly 102 (as shown in FIG. 4A), and the second tube assembly 160 can comprise the bladder 106 of the attachment mechanism 104 and the bladder 109 of the insole assembly 102 (as shown in FIG. 5A). In this regard, the tube assemblies disclosed herein (e.g., first tube assembly 120 and second tube assembly 160) are independently configured to fluidly couple a bladder of the insole assembly 102 to a bladder of the attachment mechanism 104.

Referring now to FIG. 4A, the bladder 108 of insole assembly 102 can be configured to receive any fluid therein, In various embodiments, the fluid can be a pneumatic fluid (i.e., an easily compressible gas or liquid), such as compressed air or pure gas. In various embodiments, the fluid can be a low viscosity fluid (e.g., a hydraulic fluid), In various embodiments, the fluid can comprise water. In various embodiments, the bladder 108 is disposed on the insole assembly 102 and configured to interface with the ball of the foot of the user 10 from FIG. 1 as described previously herein. In various embodiments, the insole assembly 102 can be mounted inside of a shoe or be integral therewith. In various embodiments, the bladder 108 can be sized and configured to provide a uniform pressure to bladder 105 during use of the device 100 from FIG. 1. In this regard, various sizes and shapes of the bladder 108 can be utilized to achieve the uniform pressure, such as generally spherical, rectangular prismatic, hemi-spherical, cylindrical, concave, convex, or the like.

In various embodiments, the force actuation system 110 further comprises bladder 105 of the attachment mechanism 104. The bladder 105 can be in fluid communication with the bladder 108 via a first tube 122 and a second tube 124 of tube assembly 120. Although the force actuation system 110 is illustrated with a second bladder (e.g., bladder 105), the device 100 is not limited in this regard. For example, a reservoir or a pump can replace bladder 105 and be stored in the attachment mechanism 104, in accordance with various embodiments, The bladder 105 can be coupled to the attachment mechanism 104. The bladder 105 of the attachment mechanism 104 can be configured to inflate when the bladder 108 of the insole assembly 102 is compressed, such as when a person wears insole assembly 102 and/or when a person is stepping on the ground with the insole assembly 102. As such, the bladder 105 can be configured to apply pressure to the leg of a person in response to compressing the bladder 108. In various embodiments, bladders 105, 108 are made of specialized plastic and protected by a specially designed plastic wrap. Bladders 105, 108 are sealed except for a single point where a barbed fitting is inserted and secured. The fitting protrudes through the plastic and the canvas such that a respective tube (e.g., first tube 122 for bladder 108 and second tube 124 for bladder 105) can be attached to the force actuation system 110.

In various embodiments, the tube assembly 120 comprises the first tube 122, the second tube 124, and a connector 126. The first tube 122 can extend from the bladder 108 to the connector 126. Similarly, the second tube 124 can extend from the connector 126 to the bladder 105. The connector 126 can comprise a three-way junction. In this regard, during manufacturing of the insole assembly 102 or wearable device 99 of FIG. 2B, the fluid can be laded into the bladder 108 of the attachment mechanism 104 via an inlet 125 of the junction of the connector 126 (e.g., through a one-way valve 117 and a third tube 128) as shown in FIG. 4A. In various embodiments, with combined reference to FIGS. 4A and 4B, with like numerals depicting like elements, the third tube 128 and the one-way valve 117 can be removed thereafter and the inlet 125 of the junction of the connector 126 can be sealed thereafter.

In various embodiments, the one-way valve 117 and the third tube 128 can remain to provide a bias pressuring system for the tube assembly 120. The present disclosure is not limited in this regard. Although illustrated and described, as comprising two tubes and a connector, or three tubes, a connector, and a one-way valve, various fluid assemblies can be readily apparent to one skilled in the art, and the present disclosure is not limited in this regard. For example, the fluid can be laded into bladder 105 of the attachment mechanism 104 through a single tube, which can then be fluidly be coupled to the bladder 108 of the insole assembly 102, or vice versa, in accordance with various embodiments.

In various embodiments, the tube assembly 120 can include fluid connections to a second bladder of attachment mechanism 104 and a third bladder of attachment mechanism 104, or the like to create a pressure on multiple places of the body. The present disclosure is not limited in this regard. However, transferring pressure from a single high pressure location (e.g., a ball or a heel) to a pressure point can be preferrable to provide a consistent indication to the user 10 from FIG. 1 when that part of the foot of the user 10 (e.g., a ball or a heel) is in contact with the ground and for comparison, by the user 10, of a pressure produced from stepping from one step to the next.

In a passive system, in response to the bladder 108 of the insole assembly 102 being squeezed, fluid or air moves from tubes 122, 124 to transfer the pressure and increase the size of bladder 105 of the attachment mechanism 104. This bladder 105 can push on another part of the body where the user 10 from FIG. 1 still has sensation and proprioception, such as a shank of a leg of the user 10 from FIG. 1. In this way the measured pressure in the bladder 105 of the attachment mechanism 104 is transferred from a first position (e.g., a foot) to a second position (e.g., a leg), the second position being a location that can be felt by the user 10 from FIG. 1. This is a novel method of substituting the lost sensation in one body part to be felt and measured at a secondary position on the body, in accordance with various embodiments.

In various embodiments, each bladder of the attachment mechanism 104 (e.g., bladders 105, 106 from FIG. 3) can be used to push against a respective nerve near the surface of the skin of a user 10 from FIG. 1, such as the peroneal nerve, fibular nerve, tibial nerve, or the like. In various embodiments, each bladder of the attachment mechanism 104 (e.g., bladders 105, 106 from FIG. 3) can correspond to create pressure on a different nerve when in use by a user 10 from FIG. 1. In various embodiments, each bladder of the attachment mechanism 104 (e.g., bladders 105, 106 from FIG. 3) can correspond to a same nerve when in use by a user 10 from FIG. 1.

Although described with respect to tube assembly 120 and. FIGS. 4A-B, the tube assembly 160 with bladders 106, 109 from FIGS. 5A-B can be made in the same manner and comprise the same elements of the tube assembly 120. For example, with reference now to FIGS. 5A-B, the tube assembly 160 can comprise a first tube 162. a second tube 164, a connector 166, a third tube 168, and a one-way valve 167 (as shown in FIG. 5A), the tube assembly 160 can comprise the first tube 162, the second tube 164, and connector 166 that is sealed at the inlet 165 (as shown in FIG. 5B), or the like. In various embodiments the first tube 162 is in accordance with first tube 122, the second tube 164 is in accordance with second tube 124, and/or the third tube 128 is in accordance with third tube 168. However, the present disclosure is not limited in this regard. For example, the sizing of tube assembly 120 can be different from the sizing of tube assembly 160 based on various factors (e.g., anticipated pressure differences between a ball of a foot relative to a heel of a foot, desired pressure at a bladder location of the attachment mechanism 104, or the like).

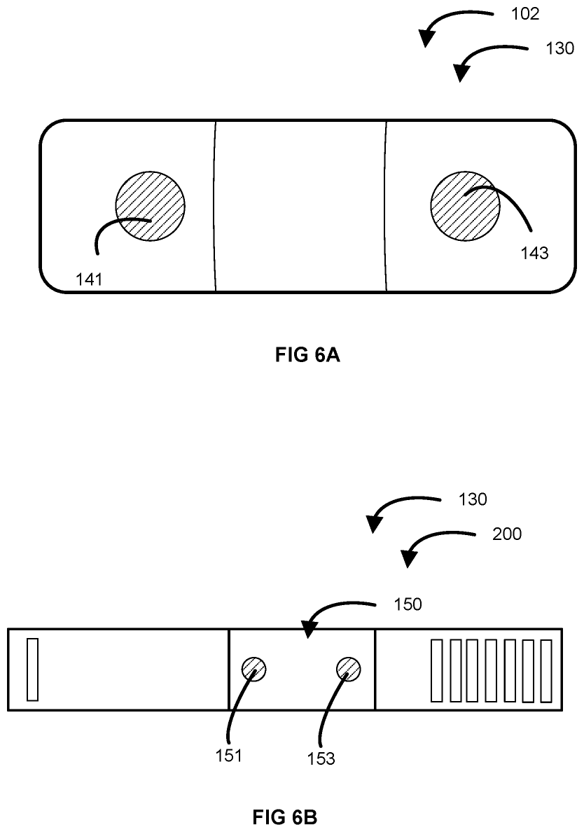

Referring now to FIGS. 6A and 6B, a force indication system 130 is illustrated, in accordance with various embodiments. The force indication system 130 can be configured to provide a visual and/or physical indication to a patient to indicate the device 100 from FIG. 1 is functioning properly. For example, in accordance with various embodiments, the force indication system 130 can be configured to provide a visual display of a force supplied in each part of the insole corresponding to a heel (e.g., bladder 109) or a toe area (e.g., bladder 108) of the insole assembly 102 by a person during operation of the device 100. Furthermore, in accordance with various embodiments, the force indication system 130 can be configured to provide a physical indication to a person that the force actuation system 110 is working.

The force indication system 130 comprises a first force sensor 141. The first force sensor 141 can be disposed near the heel of insole assembly 102. The first force sensor 141 is configured to measure a force supplied by a person during use of the device 100 from FIG. 1. The first force sensor 141 can be in electrical communication with a microcontroller via wires or wireless transmission such as Bluetooth, as described further herein. In various embodiments, the first force sensor 141 can comprise a force sensitive resistor, a force sensitive capacitor, a piezoelectric force sensor, or any other force sensor known in the art. Preferably, the first force sensor 141 comprises a force sensitive resistor. The microcontroller receives data from first force sensor 141 and interprets the data into a signal for a light array 150 to utilize, as described further herein. Although the first force sensor 141 is illustrated as communicating with a microcontroller, wireless communications are also within the scope of this disclosure.

In accordance with various embodiments, the force indication system 130 can further comprise a second force sensor 143. The second force sensor 143 can be in accordance with the first force sensor 141. The second force sensor 143 can be disposed proximate a ball of the foot. In various embodiments, a third force sensor could be provided at, or near, the toes of the user 10 from FIG. 1. In various embodiments, the number of force sensors can vary. Various force sensor combinations can be readily apparent to one skilled in the art, and the present disclosure is not limited in this regard. In various embodiments, force sensors 141, 143 are only provided at, or near, a ball of a foot and at, or near heel of a foot respectively as the ball of the foot and the heel of the foot are high pressure areas during a walking motion, in accordance with various embodiments.

In accordance with various embodiments, the force indication system 130 further comprises the light array 150. The light array 150 can be in electrical communication with the microcontroller. In various embodiments, the light array 150 can be disposed proximate a thumb side on the arm such as near a watch. In various embodiments, the light array 150 can be disposed directly on a shoe, a sandal, or the like. The light array 150 can be configured to provide a person with an indication of a force being applied by a respective portion of the insole assembly 102. For example, the light array 150 can comprise a light corresponding to each force sensor (e.g., first force sensor 141, second force sensor 143, etc.).

Referring now to FIG. 6B, a wearable device 200 of force indication system 130 is illustrated in accordance with various embodiments. In various embodiments, the light array 150 is mounted externally on the hand (e.g., as a watch, a wrist band, or the like). In this regard, the light array 150 can face the person during use.

In various embodiments, the light array 150 comprises a first light 151 and a second light 153. The first light 151 can be operably coupled to the microcontroller and configured to illuminate based on a force measured by first force sensor 141 from FIG. 5A. Similarly, second light 153 can be operably coupled to the microcontroller and configured to illuminate based on a force measured by second force sensor 143. A light array 150 as described herein, can comprise any light display, such as incandescent, fluorescent, halogen, or the like. In various embodiments, the light array 150 can preferably comprise a light emitting diode (LED) array. In various embodiments, the light array 150 can provide the person with visual cues as to the level of force the person is applying to the surface of the foot. In this regard, a person can adjust the level of force based on the color displayed by the light array 150 for a foot pressure in the insole assembly 102.

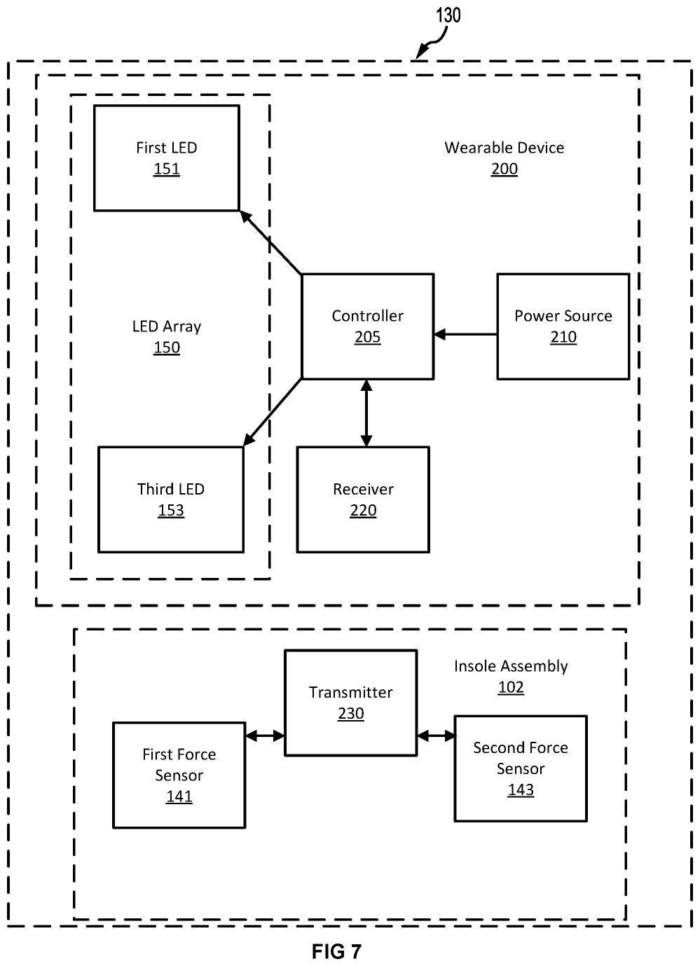

Referring now to FIG. 7, a schematic block diagram of a force indication system 130 for use in the device 100 from FIGS. 1-6B is illustrated, in accordance with various embodiments. Force indication system 130 includes a controller 205 in electronic (e.g., wireless) communication with the first force sensor 141, the second force sensor 143, a power source 210, and a light array 150. In various embodiments, controller 205 can be integrated into a microcontroller disposed to be mounted on the body. In various embodiments, the controller 205, light array 150, the power source 210 can all be mounted inside of a smartwatch. In various embodiments, controller 205 can be configured as a central network element or hub to access various systems and components of force indication system 130. Controller 205 can comprise a network, computer-based system, and/or software components configured to provide an access point to various systems and components of force indication system 130. In various embodiments, controller 205 can comprise a processor. In various embodiments, controller 205 can be implemented in a single processor. In various embodiments, controller 205 can be implemented as and can include one or more processors and/or one or more tangible, non-transitory memories and be capable of implementing logic. Each processor can be a general purpose processor, a digital signal processor (DSP), an application specific integrated circuit (ASIC), a field programable gate array (FPGA) or other programable logic device, discrete gate or transistor logic, discrete hardware components, or any combination thereof. Controller 205 can comprise a processor configured to implement various logical operations in response to execution of instructions, for example, instructions stored on a non-transitory, tangible, computer-readable medium configured to communicate with controller 205. In various embodiments, the power source 210 can comprise a battery.

System program instructions and/or controller instructions can be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments, the light array 150 comprises a first light 151 and a second light 153. Each light in the light array 150 can correspond to a respective force sensor (e.g., first force sensor 141 or second force sensor 143). For example, first force sensor 141 can correspond to first light 151, and the second force sensor 143 can correspond to the second light 153. In various embodiments, the light array 150 comprises a number of LEDs corresponding to the number of force sensors of the respective device 100 from FIGS. 1-6B. For example, when two force sensors are used, two LEDs in a light array 150 can be used. In this regard, a patient can be provided a visual indication of a force supplied by a respective foot location (e.g., heel, toe, middle, etc.) corresponding to reading from each force sensor of the device 100 from FIGS. 1-6. However, the present disclosure is not limited in this regard, for example, an array of lights for each force sensor may be supplied in accordance with various embodiments. For example, with an array of lights, each light in the array of lights can correspond to a color based on a force measurement of the respective force sensor (e.g., first force sensor 141 or second force sensor 143), such as a green light for force in a desirable range, yellow for a force outside the desirable range but within an acceptable range, and/or red for a force outside the acceptable range, in accordance with various embodiments.

In various embodiments, the first force sensor 141 is configured to measure a force supplied proximate the heel of a user 10 from FIG. 1. In response to measuring the force, the controller 205 can interpret the measured force and supply a signal to the first light 151 in the light array 150. The signal supplied to the light array 150 can illuminate proportionate to a force supplied by at the heel. For example, if the measured force is below a first force threshold, the first light 151 can illuminate a first color (e.g., red). If the measured force is above the first force threshold and below a second force threshold, the first light 151 can illuminate a second color (e.g., yellow). It the measured force is above the second force threshold, the first light 151 can illuminate a third color (e.g., green). Any number of colors arranged in any order can be a design choice and one skilled in the art can recognize several color orders and be within the scope of this disclosure. For example, an additional force threshold can be provided between the first force threshold and the second force threshold and correspond to a fourth color (e.g., orange).

In various embodiments, the second force sensor 143 is configured to measure a force supplied at the hall of the foot. In response to measuring the force, the controller 205 can interpret the measured force and supply a signal to the second light 153 in the light array 150. The second light 153 can be in accordance with the first light 151 a as described herein.

In various embodiments, the force indication system 130 comprises the wearable device 200 and the insole assembly 102. In various embodiments, the wearable device 200 includes a receiver 220 (e.g., a receiver only or a transceiver) and the insole assembly 102 includes a transmitter 230 (e.g., a transmitter only or a transceiver). In this regard, transmitter 230 of the insole assembly 102 can be configured to transfer sensor data (e.g., wirelessly) from force sensors 141, 143, via transmitter 230 of the insole assembly 102 to receiver 220 of the wearable device 200, in accordance with various embodiments. Thus, the force indication system 130 can be a wireless force indication system where force detected proximate a foot of a user 10 from FIG. 1 can be transferred to a wearable device 200 proximate a wrist of a user 10 from FIG. 1, in accordance with various embodiments.

An exemplary embodiment is a system intended for use in gauging the force exerted by or at the foot. Certain individuals suffering from neurological disease sometimes lose an ability to gauge the force on the bottom of the foot. The device 100 has a potential to increase their quality of life.

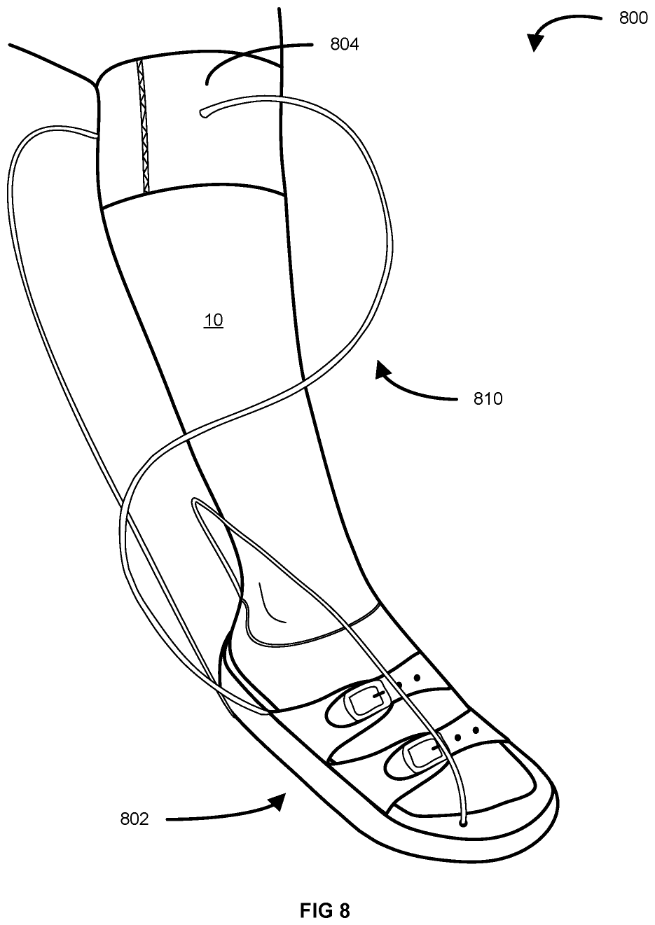

Referring now to FIG. 8, a perspective view of a device 800 in use is illustrated, in accordance with various embodiments. The device 800 comprises an active system for force/pressure indication, in accordance with various embodiments. The device 800 comprises an insole assembly 802 and an attachment mechanism 804. In various embodiments, the insole assembly 802 can comprise various electrical components embedded therein or otherwise coupled to device 800. In various embodiments, the insole assembly 802 can be integral with a shoe, a sandal or any other component configured to be wearable on a foot of a user 10. In various embodiments, the attachment mechanism 804 is configured to couple to a body part of a user 10 (e.g., above the calf, on the shank, or any other area of a leg of user 10). In various embodiments, the attachment mechanism 804 comprises a cuff, a strap, or any other component configured to couple to a leg of a user 10.

In various embodiments, the device 800 comprises a force actuation system 810. The force actuation system 810 is configured to send an electrical signal in response to a pressure being supplied to an area of the insole assembly 802 as described further herein.

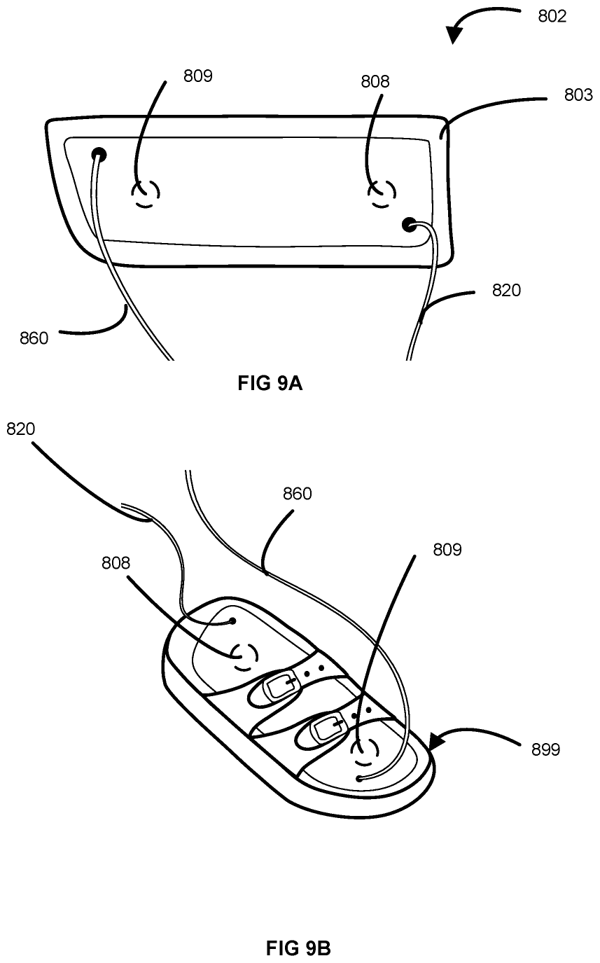

With reference to FIG. 9A and FIG. 9B, a top down view of the insole assembly 802 of the device 800 without the wearable portion (e.g., the shoe, the sandal, etc.) (FIG. 9A) and a perspective view of the insole assembly 802 (FIG. 9B), are illustrated in accordance with various embodiments. In various embodiments, the insole assembly 802 includes an insole 803 and at least one sensor (e.g., sensor 808 and/or sensor 809). In various embodiments, sensor 808 is disposed at, or proximate, a heel of the insole assembly 802 and sensor 809 is disposed at, or proximate, a ball of the insole assembly 802.

In various embodiments, sensors 808, 809 are embedded within the insole 803 or a wearable device 899. In various embodiments, the sensors 808, 809 are electrically coupled (e.g., via electrical wires disposed in wiring harness assemblies 820, 860) to an electro-mechanical device (e.g., a mechanical plunger, a solenoid-activated plunger, etc.). Although illustrated with wiring harness assemblies 820, 860, the present disclosure is not limited in this regard. For example, the device 800 can be configured to transmit signals wirelessly to the electromechanical actuators as described further herein, and still be within the scope of this disclosure. An “electro-mechanical actuator,” as described herein refers to any actuator configured to actuate in response to receiving an electrical input signal. In various embodiments, a pressure supplied by the actuator may vary based on a respective current of the electrical input signal, the pressure supplied may be constant regardless of the electrical input, or the like. The present disclosure is not limited in this regard.

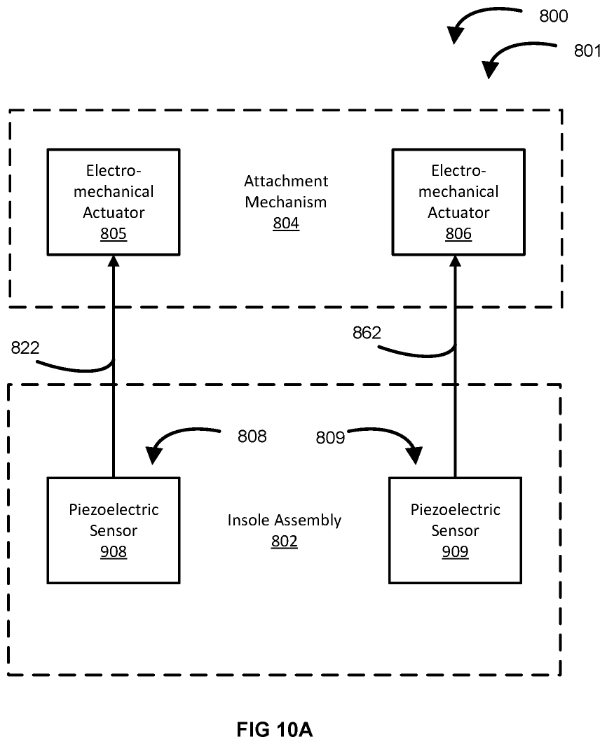

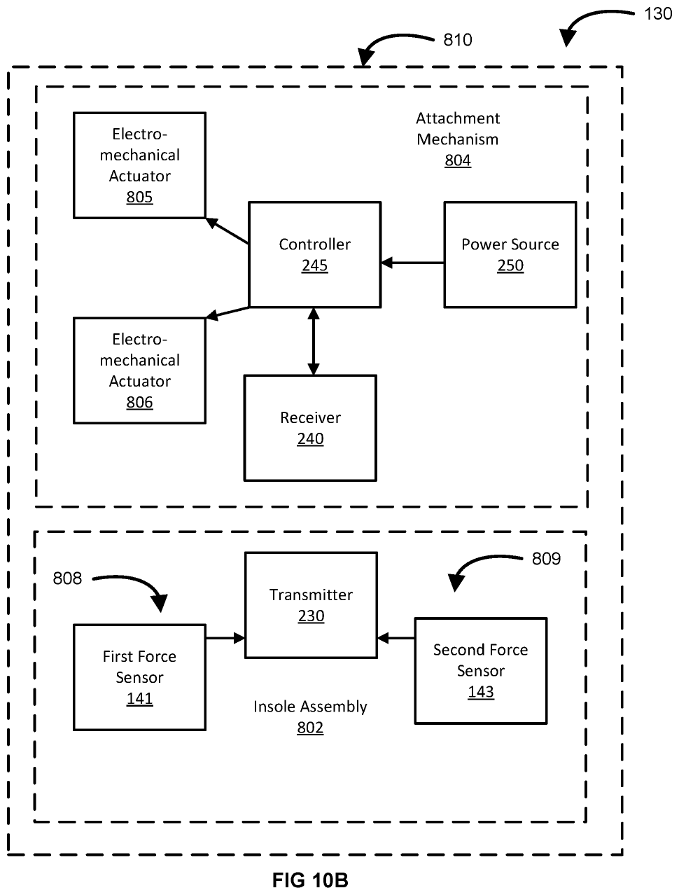

Referring now to FIG. 10A, a schematic view of a control system 801 for the device 800 is illustrated, in accordance with various embodiments. In various embodiments, the sensor 808 of the insole assembly 802 is electrically coupled (e.g., via conductive wires 822) to an electro-mechanical actuator 805 (e.g., a solenoid activated plunger, a mechanical plunger, etc.). Similarly, the sensor 809 is electrically coupled (e.g., via conductive wires 862) to an electro-mechanical actuator 806. In various embodiments, the conductive wires 822 can be disposed in the wiring harness assembly 820 from FIG. 9B and the conductive wire 862 can be disposed in the wiring harness assembly 860 from FIG. 9B. However, the present disclosure is not limited in this regard. For example, the conductive wires 822, 862 can be routed in a single wiring harness (e.g., wiring harness assembly 820 or wiring harness assembly 860) and still be within the scope of this disclosure.

In various embodiments, the sensor 808 is a piezoelectric sensor 908, and the sensor 809 is a piezoelectric sensor 909. In this regard, the piezoelectric sensors 908, 909 are configured to convert mechanical energy (e.g., via compression of the sensor) to an electrical signal. In this regard, the piezoelectric sensors 908, 909 may be self-sustaining without an external power source. Thus, in response to the piezoelectric sensor 908 (or the piezoelectric sensor 909) being compressed, an electrical signal can be sent via an input wire in the conductive wires 822 (or conductive wires 862) to the electro-mechanical actuator 805 (or the electro-mechanical actuator 806). In response to receiving the electrical signal, the electro-mechanical actuator 805 (or electro-mechanical actuator 806) can actuate a plunger, a button, or the like to generate a pressure on a leg of a user 10 from FIG. 8 (e.g., a shank or the like). In this regard, as described previously herein, a pressure correlating to a pressure supplied during a step can be transferred from a location of a user 10 from FIG. 8 without feeling (e.g., a heel or a sole) to a location with feeling (e.g., a pressure point on a leg of the user 10, or the like). Furthermore, in accordance with various embodiments, pressure supplied by the electro-mechanical actuators 805, 806 may be in different locations, so a user 10 from FIG. 8 can associate a pressure from an electromechanical actuator (e.g., electro-mechanical actuators 805, 806) with a part of a foot that is supplying the pressure (e.g., a ball or a heel). In various embodiments, the electro-mechanical actuators 805, 806 can be used to push against a respective nerve near the surface of the skin of a user 10 from FIG. 1, such as the peroneal nerve, fibular nerve, tibial nerve, or the like. In various embodiments, each sensor 808, 809 can correspond to create pressure on a different nerve when in use by a user 10 from FIG. 1. In various embodiments, each electro-mechanical actuator 805, 806 of the attachment mechanism 804 can correspond to a same nerve when in use by a user 10 from FIG. 1.

Referring now to FIG. 10B, the device 800 having the force actuation system 110 can be incorporated with the force indication system 130 from FIGS. 6A-7. For example, the attachment mechanism 804 of the device 800 can comprise a controller 245, a receiver 240 (e.g., a receiver only or a transceiver), and a power source 250. In various embodiments, attachment mechanism 804 can replace the wearable device 200 from FIG. 6B or the attachment mechanism 804 can be used in combination with the wearable device 200 from FIG. 6B. The present disclosure is not limited in this regard.

In various embodiments, the sensor 808 comprises the first force sensor 141 and the sensor 809 comprises the second force sensor 143. In this regard, the transmitter 230 is configured to transmit sensor data from the first force sensor 141 and the second force sensor 143 to the receiver 240 of the attachment mechanism 804. The receiver 240 is in electrical communication with a controller 245.

In various embodiments, controller 245 can be integrated into a microcontroller disposed in the attachment mechanism 804 and configure to be mounted on the body as described previously herein. In various embodiments, the controller 245, the electro-mechanical actuators 805, 806, and the power source 250 can all be mounted inside of the attachment mechanism 804. In various embodiments, controller 245 can be configured as a central network element or hub to access various systems and components of force actuation system 810. Controller 245 can comprise a network, computer-based system, and/or software components configured to provide an access point to various systems and components of force actuation system 810. In various embodiments, controller 245 can comprise a processor. In various embodiments, controller 245 can be implemented in a single processor. In various embodiments, controller 245 can be implemented as and can include one or more processors and/or one or more tangible, non-transitory memories and be capable of implementing logic. Each processor can be a general purpose processor, a digital signal processor (DSP), an application specific integrated circuit (ASIC), a field programable gate array (FPGA) or other programable logic device, discrete gate or transistor logic, discrete hardware components, or any combination thereof. Controller 245 can comprise a processor configured to implement various logical operations in response to execution of instructions, for example, instructions stored on a non-transitory, tangible, computer-readable medium configured to communicate with controller 245. In various embodiments, the power source 250 can comprise a battery.

In various embodiments, the first force sensor 141 is configured to measure a force supplied proximate the heel of a user 10 from FIG. 8 as described previously herein. In response to measuring the force, the transmitter 230 can transmit the force data to the receiver 240, which can relay the force data to the controller 245. The controller 245 can then interpret the force data and supply a signal to the electro-mechanical actuator associated with the force sensor that measured the force (e.g., first force sensor 141 or second force sensor 143. For example, in response to receiving, via the controller 245, a force data from the first force sensor 141, the controller 245 can send an electrical signal to electro-mechanical actuator 805. In various embodiments, the electrical signal can correspond to a pressure supplied by the electro-mechanical actuator 805 to the leg of the user 10 from FIG. 8. For example, the lower a force measured by the first force sensor 141, the lower a pressure supplied by the electro-mechanical actuator 805 may be. Similarly, the higher the force measure by the first force sensor 141, the higher the pressure supplied by the electro-mechanical actuator 805 may be. In this regard, a pressure supplied by the electro-mechanical actuator 805 can correspond directly to a measured force by the first force sensor 141, in accordance with various embodiments. Thus, a user 10 from FIG. 8 can correlate a pressure supplied to a pressure point that the user 10 can feel on the leg of the user 10 to a pressure the user 10 is applying to the foot of the user 10 (e.g., a heel for first sensor 141), in accordance with various embodiments.

In various embodiments, the controller 245 may be configured to compare the measured force from a respective force sensor (e.g., first force sensor 141 or second force sensor 143) and compare the measured force to predetermined ranges as described previously herein. In this regard, in response to being in a desired pressure range, the controller 245 may be configured to do nothing not apply a force to the leg of the user 10 from FIG. 8 through a respective electro-mechanical actuator), and in response to being outside the desired pressure range, the controller 245 may be configured to send an electrical signal to command an associated electro-mechanical actuator (e.g., electro-mechanical actuator 805 or electro-mechanical actuator 806) to actuate and contact a pressure point on a leg of the user 10 from FIG. 8. In this regard, the force actuation system 810 may be configured to only actuate in response to a user 10 from FIG. 8 or not supplying enough force or supplying too much force while walking as determined by the controller 245.

While the principles of this disclosure have been shown in various embodiments, many modifications of structure, arrangements, proportions, the elements, materials and components, used in practice, which are particularly adapted for a specific environment and operating requirements can be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that can cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A device, comprising:
an insole assembly comprising a first bladder; and
a force actuation system comprising the first bladder and a second bladder, the first bladder in fluid communication with the second bladder, the force actuation system configured to displace a fluid from the first bladder to the second bladder in response to displacement of the first bladder.

2. The device of claim 1, wherein the force actuation system further comprises a tube assembly,
wherein the first bladder is in fluid communication with the second bladder via the tube assembly, and
wherein the second bladder is configured to contact a person during use of the device.

3. The device of claim 2, wherein the tube assembly comprises a first tube, a connector, and a second tube,
wherein the first tube is disposed between a first port of the connector and the first bladder, and
wherein the second tube is disposed between the second bladder and a second port of the connector.

4. The device of claim 3, wherein the connector comprises a third port,
wherein the third port is sealed, and
wherein the third port is configured to adjust a bias pressure.

5. The device of claim 2, wherein the second bladder is configured to create a pressure on a nerve of a leg.

6. The device of claim 1, wherein the first bladder is configured for passive actuation during use of the device.

7. The device of claim 1, further comprising a force indication system comprising a plurality of force sensors, each force sensor disposed in the insole assembly.

8. The device of claim 1, further comprising an attachment mechanism, wherein the attachment mechanism comprises the second bladder.

9. The device of claim 8, wherein the force actuation system further comprises a third bladder and a fourth bladder, the third bladder in fluid communication with the fourth bladder, the insole assembly comprising the third bladder, the attachment mechanism comprising the fourth bladder, the first bladder disposed proximate a heel of a user when in use, and the second bladder disposed proximate a toe of the user when in use.

10. A force actuation system for a device, comprising:
a first bladder configured to be disposed proximate a foot of a user when in use; and
an attachment mechanism comprising a second bladder in fluid communication with the first bladder, the force actuation system configured to displace a first fluid from the first bladder to the second bladder in response to displacement of the first bladder.

11. The force actuation system of claim 10, further comprising:
a third bladder configured to be disposed proximate a toe of the user when in use, wherein the first bladder is configured to be disposed proximate a heel of the user when in use; and
a fourth bladder in fluid communication with the third bladder, the force actuation system configured to displace a second fluid from the third bladder to the fourth bladder in response to displacement of the second bladder.

12. The force actuation system of claim 10, wherein the attachment mechanism is configured to couple to a leg of the user.

13. The force actuation system of claim 10, further comprising an insole assembly comprising the first bladder.

14. The force actuation system of claim 10, further comprising a piece of footwear, wherein the first bladder is disposed in the piece of footwear.

15. The force actuation system of claim 10, wherein the force actuation system is a passive force actuation system.

16. The force actuation system of claim 10, wherein the second bladder is configured to be disposed proximate a nerve of the user when in use.

17. The force actuation system of claim 14, wherein the attachment mechanism comprises an attachment strap.

18. A force indication control system for a device, the force indication control system comprising:
a first force sensor disposed in an insole;
a second force sensor disposed in the insole;
a transmitter in electrical communication with the first force sensor and the second force sensor;
a receiver;
a controller in electrical communication with the receiver; and
a tangible, non-transitory memory configured to communicate with the controller, the tangible, non-transitory memory having instructions stored thereon that, in response to execution by the controller, cause the controller to perform operations comprising:
receiving, by the controller and through the receiver, a first force measurement from the first force sensor, and
commanding, by the controller, one of actuation of an actuator or illumination of a light based on the first force measurement from the first force sensor.

19. The force indication control system of claim 18, further comprising:
an insole assembly comprising the first force sensor, the second force sensor, and the transmitter; and
a wearable device comprising the receiver and the controller.

20. A device, comprising:
an insole assembly comprising a first sensor; and
a force actuation system comprising an electro-mechanical actuator in communication with the first sensor in response to pressure at the first sensor.

21. The device of claim 20, wherein:
the force actuation system further comprises an electrical assembly,
the first sensor is in communication with the electro-mechanical actuator, and
the electro-mechanical actuator is configured to contact a person during use of the device.

22. The device of claim 20, wherein a force supplied by the electro-mechanical actuator is configured and adjusted to the pressure measured at the first sensor.

23. The device of claim 20, wherein the electro-mechanical actuator is configured to create a pressure on a nerve of a leg.

24. The device of claim 20, wherein multiple electro-mechanical actuators are configured to create a contact pressure on a person based on the first sensor and a second sensor in the insole assembly.
